(19) United States
(12) Patent Application Publication
(10) Pub. No.: US 2019/0370873 A1
(43) Pub. Date: Dec. 5, 2019

(54) INTERACTIVE SHOPPING AND METHOD FOR MAKING CUSTOMIZED SLIME TOY

(71) Applicants: Linda Ing-GILBERT, Toronto (CA); Adam GILBERT, Toronto (CA); Eric GILBERT, Toronto (CA); Juliette GILBERT, Toronto (CA)

(72) Inventors: Linda Ing-GILBERT, Toronto (CA); Adam GILBERT, Toronto (CA); Eric GILBERT, Toronto (CA); Juliette GILBERT, Toronto (CA)

(21) Appl. No.: 15/993,121

(22) Filed: May 30, 2018

(51) Int. Cl. G06Q 30/06; G07F 13/10

(52) U.S. Cl. CPC G06Q 30/0621; G07F 13/10; G06Q 30/0643

(57) ABSTRACT

The present invention is a method for providing a workshop in which the customers can make a personalized slime toy. The customers can go through a variety of stations which are specifically designed for various process of making a slime toy. The workshop comprises of a variety of stations comprising a selecting station, a dispensing station, an automatic mixing station, a hand mixing station, a personalizing station and a checkout station. Customers can select from variety of ingredients to make their desired slime. Specifically, the stations are designed to allow a user in the workshop to customize their Slime toy as part of the play experience by interacting in every process of making a Slime.

### FIELD OF THE INVENTION

The present invention relates in general to interactive toy assembly workshops and in specific to providing a method for making a sensory Slime toy.

### BACKGROUND OF THE INVENTION

Slime toys are now one of the popular toys among children and adolescents. Slime toys, hereinafter referred to as Slime, generally comprise of a non-toxic viscous, squishy material made primarily from guar gum. The ingredients of a slime can be separately obtained and mixed using a mixing instruction to create a Slime. In addition, there are several Slime making kits for home or pre-fab Slimes. Making a Slime at home is a messy process, as it usually takes several trials before a child can get the right mixtures for a good quality Slime.

The present invention is a One-stop Slime making workplace, which eliminates the issues of making slime at home. Currently available Slime toys are pre-fabricated Slime making kits, where all the ingredients are pre-measured, or all the ingredients are purchased and mixed according to a slime making procedure. However, the later method can rarely result in a high quality slime and the child may waste a lot of time and money repeating the process. Most importantly, the available method does not provide an “interactive” experience that such games can provide. The present invention will overcome these problems by providing an interactive workshop, where the customer can purchase all the ingredients and mix and make their Slime toy in an interactive environment with the assistance of in-store Slime specialists, answering questions.

### SUMMARY OF THE INVENTION

The present invention is a method for providing an interactive workshop in which the customers (e.g., children) can make their personalized Slime toy. The customers can go through a variety of stations, which are specifically designed for various process of making Slime. The workshop is a hands-on play environment in which the customer participates in an interactive activity. In fact, the customer is the creator of his/her own customized toy.

The method provides an interactive shopping experience for a customer that enhances the overall pleasure of selecting, mixing and making a Slime toy with an accurate viscosity. This is achieved through by a set of specialized machines.

The workshop comprises of a variety of stations, which are specifically related to various production tasks in the process of making the Slime. Customers select their own ingredients from a variety of different ingredients to make their desired Slime. The stations are designed to allow a user in an interactive workshop to customize their Slime as part of a play experience by being involved in every process of making the Slime. The workshop is decorated with a theme to encourage the customer to become involved in the process, in part, by the theme chosen.

Different stations in the workshop provide an activity. The stations comprise of a Slime selecting station, a dispensing station, a mixing station, a hand mixing station, a personalizing station and a checkout station.

In the Slime selecting station, the user can select the type and form of Slime from a menu of Slimes. One embodiment of the Slime selecting station comprises of touch screen devices presenting a slime menu of a set of slimes on the display with the price of each slime form. The user selects from the slime menu using the interface of the device.

The display further represents a set of ingredients for each of selected slimes. The display further presents a set of add-ins and the customer selects from the set of add-ins to complete the selected slime. When the customer inputs into the interface that the selected slime is complete, the electronic display presents a visual representation of the selected slime with add-ins on the display and allows the customer to change any of the selections. The customer can make any modification on amount of each ingredients to change the viscosity or other property of the slime. The display further provides price of each add-ins as additional price for example 50 cents to $1.00/each.

The selecting station further has a container dispensing slot, which provides a container with a readable tag such as a barcode thereon that contains a set of information regarding the selected slime.

The next station is the dispensing station, where a set of dispensing machines dispense different ingredients needed to make the selected slime. The dispensing station also provides the selected add-ins for making a customized Slime. The container with the barcode is set in the dispensing station. The dispensing station will read and recognize the barcode and determine the selected ingredients. Different dispensing machines dispense the right amounts of ingredients into the container.

Barcode scanners (or other similar tag readers) are installed in the dispensing station, and in other stations of the workshop, to identify every container. The scanners are mounted on the stations where the container with a barcode thereon will be placed. The scanners are generally designed to read information associated with the form of the Slime. By scanning the barcode, the information associated the Slime can be transferred between stations as the user moves through the workshop. All stations are generally in communication with other stations in the workshop through a Network.

In one embodiment of the present invention the dispensing-machines are made of transparent material so that all the processes can be visible by the customer. The customer can observe which ingredients or add-ins are selected to make their Slime toy. The dispensing machines have a plurality of chambers and a delivery device which direct the materials to a nozzle configured for ejecting a predetermined amount of the ingredients or add-ins inside a container.

Once the container is filled with the selected ingredients and the add-ins, the customer is directed to the mixing station where a mixing machine is situated to mix the set of ingredients at a predefined condition to create the selected slime. The Retail Slime Store Associate Specialists are there to help the customers and answer the questions.

The final station is a personalizing station. The personalizing activity can be assisted through the associates in the workshop. The customer will be directed to a sticker label making machine and obtain a printout sticker with a picture of the creator and their descriptive words of the Slime toy thereon. The customer will be asked to use descriptive words to describe what they have experienced, their senses and what they were feeling; slippery, slimy, soft, squishy, heavy and smells to specially stamp their Slime.

It is an object of the present invention to provide an interactive workshop for selecting, purchasing the ingredients of making Slime toy and mixing with supervision of like-minded Retail Specialists.

It is another object of the present invention to provide an enjoyable and educational environment for children to learn about chemical polymers and the chemical concepts such as consistency, viscosity and the Slime experts teach them about how ingredients react to one another.

It is an object of the present invention to provide a method of making a Slime toy in which the customer takes part of the process of preparing the toy.

It is an object of the present invention to provide a solution for customers to be able to make a Slime without having to go and get all the multiple materials and try to follow an instruction.

It is another object of the present invention to prevent the customers of wasting their time to shop for multiple ingredients from different places.

It is another object of the present invention to provide a method for making a Slime with 100% accurate consistency.

It is another object of the present invention to provide a method of making Slime toy without any mess and the dreaded inevitable clean up afterwards.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1 shows a front perspective view of the embodiment of an interactive sensory Slime making workshop.

FIG. 2 shows a front perspective view of the storefront of the embodiment of an interactive sensory Slime making workshop.

FIG. 3 shows a front perspective view of the selecting station of an embodiment of the present invention.

FIG. 4 shows a front perspective view of the selecting station of an embodiment of the present invention including additional displays.

FIG. 5A shows a front perspective view of the dispensing station of an embodiment of the present invention.

FIG. 5B shows a front perspective view of the dispensing station of an embodiment of the present invention.

FIG. 6A shows a front perspective view of the mixing station of an embodiment of the present invention.

FIG. 6B shows a top elevation view of the mixing station of an embodiment of the present invention.

FIG. 7 shows a perspective view of the personalizing station according to the present invention.

FIG. 8 show a personalized Slime toy according to the present invention.

FIG. 9 is a diagram showing the steps of making a sensory Slime toy in an interactive workshop according to the present invention.

### DETAILED DESCRIPTION OF PREFERRED EMBODIMENTS

The figures are not intended to be exhaustive or to limit the present invention to the precise form disclosed. It should be understood that the invention can be practiced with modification and alteration, and that the disclosed technology be limited only by the claims and equivalents thereof.

The method disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

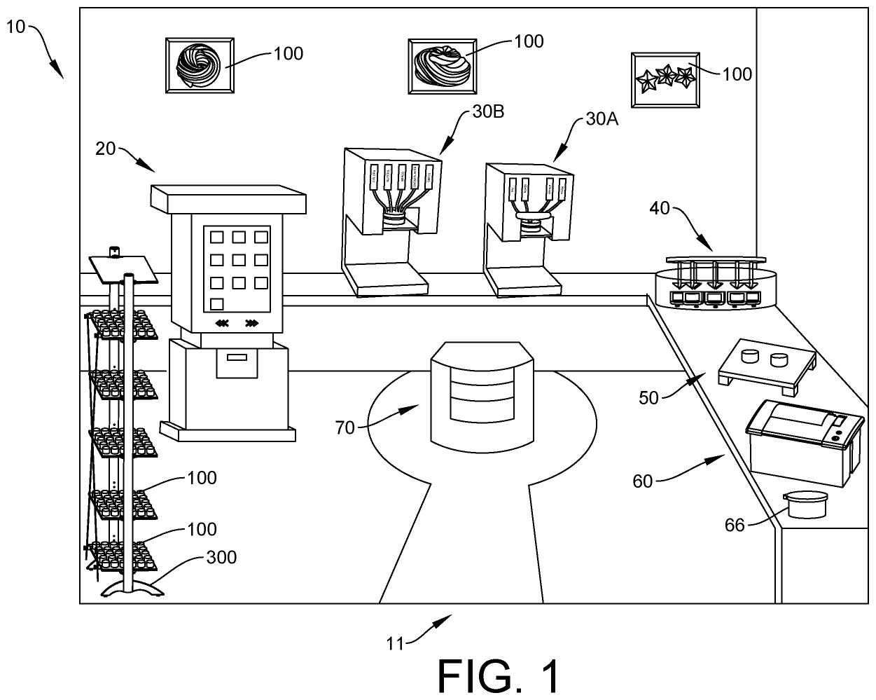

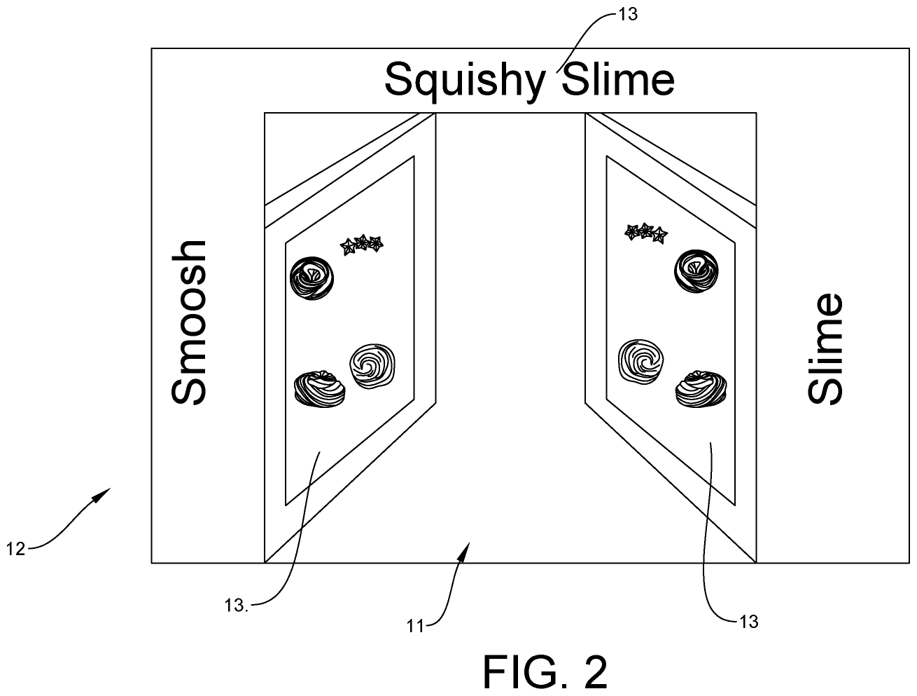

FIGS. 1 and 2 show an embodiment of an interactive Slime toy workshop 10. The workshop 10 comprises of several stations 20, 30A, 30B, 40, 50, 60, 70. These stations serve a variety of functions and engage a customer (normally a child) in selecting and preparing a Slime toy. Specifically, the stations are designed to allow customers to customize their Slime toy. A child enters an interactive workshop 10 which is decorated with a theme to encourage the customer to become involved in the process.

There are different stations in the workshop 10 comprising selecting station 20, dispensing stations 30A, 30B, automatic mixing station 40, hand mixing station 50, personalizing station 60, and checkout station 70.

The workshop 10 is decorated in a decorative theme. All the stations follow the same theme to attract the customer. The customer can approach the workshop 10 through the entrance 11.

The storefront 12 comprise a transparent or partially transparent screen, so that one can see into the workshop 10. Alternatively, the storefront 12 may include display 13 for digital advertising to enhance walkthrough interest. The storefront 12 includes digital images to be associated with the squishy colourful Slime toys of the workshop 10 or interactive tasks and may directly interface with the workshop's product.

Referring to FIGS. 1, 3 and 4 the first station is a selecting station 20 comprising of a touch screen device for self-service or minimally assisted service 21. The device 21 can be selected from stand-alone touch screen such as a Self-service-digital kiosk or computer monitors with Wi-Fi communication technology well known in prior art.

In accordance with this invention, the device 21 integrates a set of existing tools into a self-service unit for utilization in selecting and ordering Slime toy form. The customer will be directed to the kiosks 21 to select from a wide variety of slime toy forms menu 22.

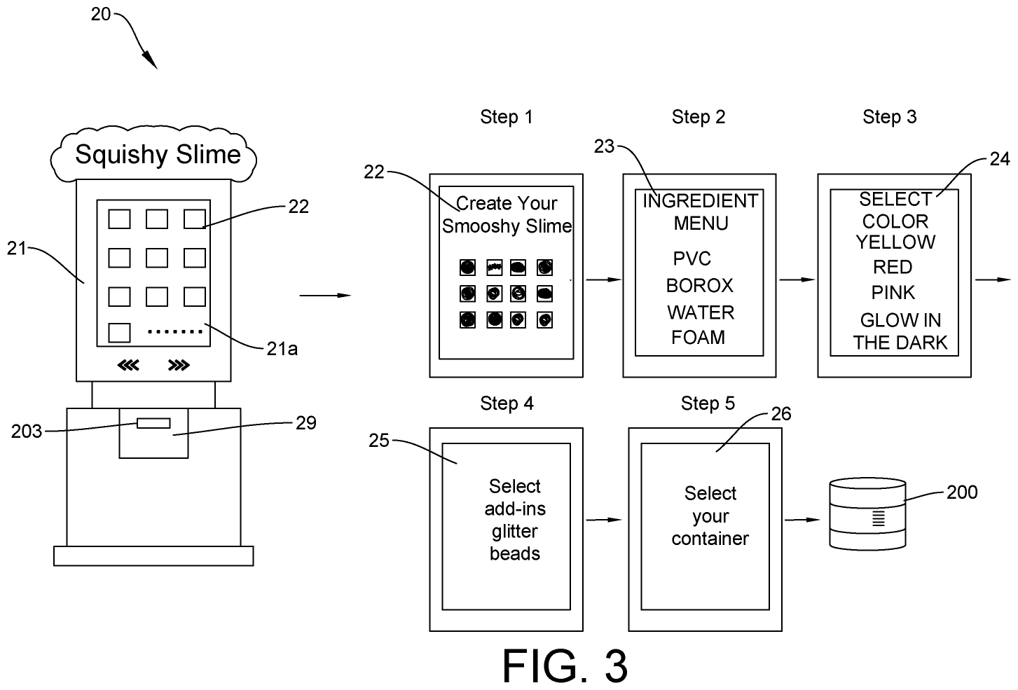

The steps of selecting customized Slime is shown in FIG. 3. The first step of making Slime generally takes place in the selecting station 20. The customer selects from a variety of Slimes by selecting from the menu 22 on the touch screen 21a. The steps of selecting a Slime form comprising: presenting a slime menu 22 of a set of slimes on the display and selecting one of set of slimes from the slime menu 22 (step 1). presenting a set of ingredients on the display and selecting the ingredients 23 (step 2), presenting a set of add-ins on the display comprising colours 24 (step 3), glitters 25 (step 4) and selecting add-ins to complete a selected slime. The menu provides the price of each Slime toy form and the additional price for add-ins.

When the selected slime is complete the display presents a visual representation of the selected slime with add-ins on the display and allows the customer to change any of the selections. The customer selects a container 26 (step 5) to proceed in the workshop 10.

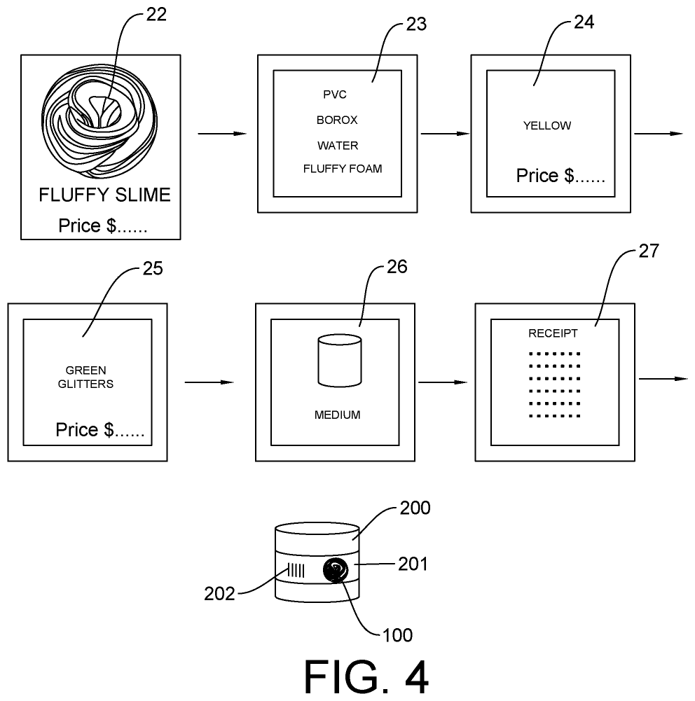

According to FIG. 4, by touching each image on the menu 22, information of the ingredients of the selected Slime and the science behind it will appear 23. For example: The customer selects the image of “Fluffy Slime” 22, which will display the ingredients 23: PVC, Borax, Water, and Fluffy foam.

After selecting the form of the Slime, the customer will select a variety of add-ins from the menu. The add-ins menu comprising: food colourings 24, (glitters, beads, soap flakes, Gold Leafs) 25 and Scents comprising Lavender, Eucalyptus, Coconut, Lemon, Honey and other decorative materials to add to the base slime toy batch.

According to FIGS. 3 and 4 again the selecting station further has a container dispensing slot 29. Once the customer selected the Slime form a screen will be shown to choose the size of the container (step 26). The containers 200 will be provided in various sizes of small, medium and large. Once the container is selected, the system provides the receipt (step 27) and the container 200 with a label thereon 201. The label contains all the information about the selected slime. The label 201 contains a readable tag such as a barcode 202 and an image of the selected Slime toy 100. The label 201 may also provide the information about the ingredients.

As shown in FIG. 1 to help the customer choose a slime form, ready-made Slimes are placed on decorative containers on display stands or platforms 300 all over the workshop 10 so that the new customers can touch and feel them.

The workshop stations may include a scanner 203 for reading bar code 202, or any other machine-readable code. The scanners 203 are mounted on the stations, where the container with a barcode 202 thereon will be placed. The scanners 203 are generally designed to read information associated with a Slime toy form 100 by scanning the barcode 202, which allows for information associated with the Slime to be transferred between stations as the user moves through the workshop 10.

All the stations in the workshop communicate with each other through a network. The information is stored in the barcode 202 and is readable by barcode scanners 203 on each station. The information may include the type of the Slime, ingredients, colours and decorative add-ins, consistency and the amount.

The workshop 10 is supervised by Retail Slime Store Associate Specialists. The specialists are there to assist the customers to operate the devices in each station and help the younger customers and answer the questions.

The stations in the workshop 10 communicate through a high-speed Wi-Fi supported system that connects it to the shop computer. All the devices in the environment have a server, a Central Processing Unit, the Logical Unit and Memory components and an in-built Wi-Fi system in the motherboard unit. The workshop 10 offers a wireless connectivity to the stations of the workshop 10.

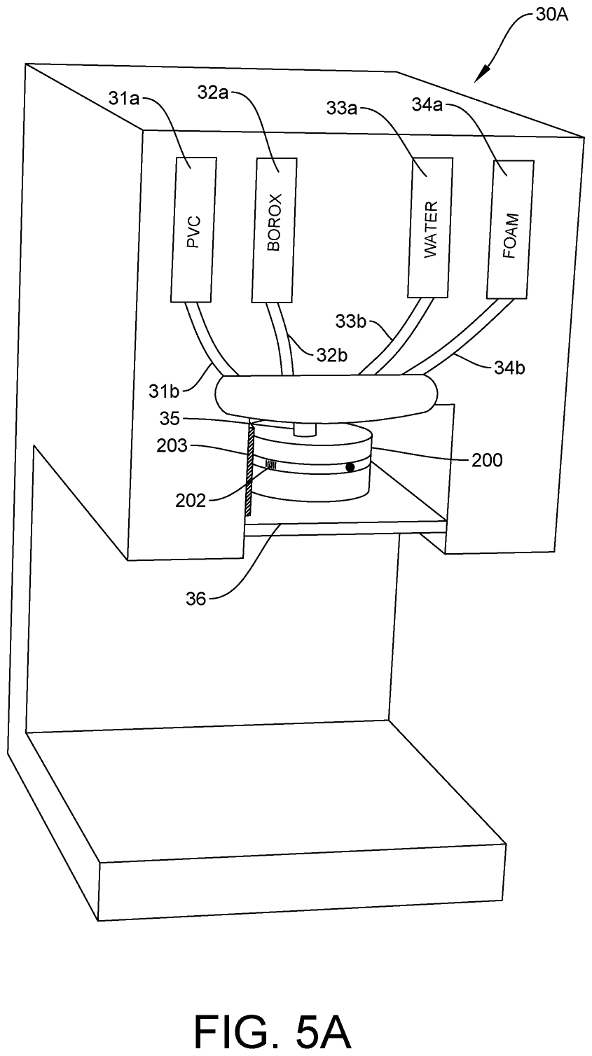

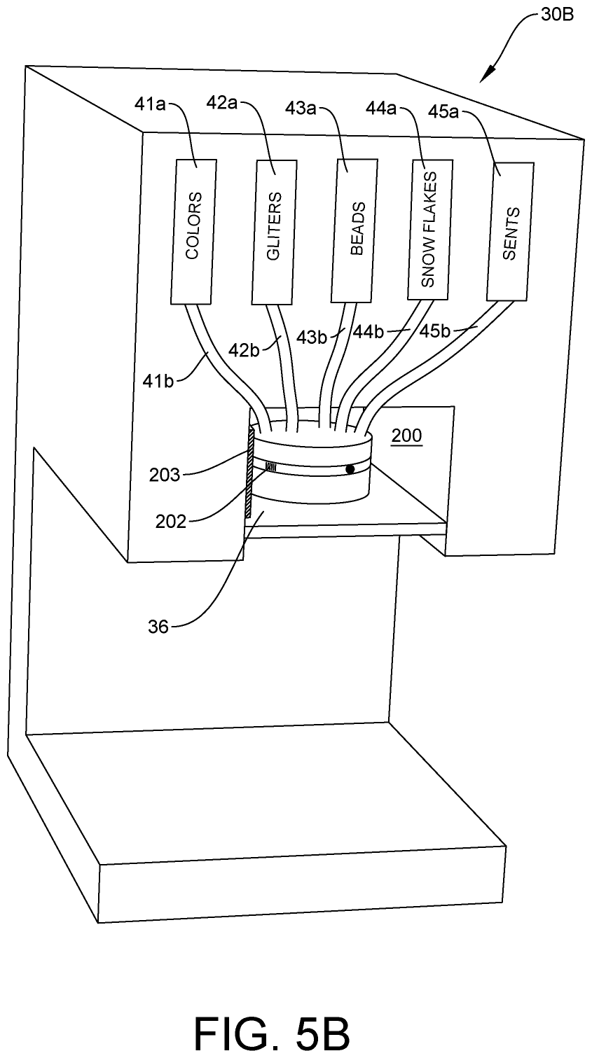

The next station is a dispensing station where a plurality of ingredients-dispensing machines and add-ins dispensing machines are placed. According to FIGS. 5A and 5B the ingredients-dispensing machines 30A are programmed to dispense the ingredients based on the order of the customer.

The add-ins dispensing machines 30B comprise of a variety of decorative add-ins and colours to add and customize the Slime toy based on the customer's order. The dispensing devices 30A and 30B comprising a plurality of chambers to be filled with components to create variety forms of Slime toys. A predetermined amount of each component dispenses through a nozzle into customers container 200.

Slime toys 100 can be created in variety forms. The most popular forms are: OG Slime, Fluffy Slime, Putty Slime, Butter Slime, Soap Slime (Epsom salt & clear soap). The menu options could vary according to the seasons, holidays, such as Slime with a Halloween twist, Christmas Slime with snowflakes, glowing in the dark Slimes for parties, Heat Sensitive Colour Changing Slime, etc.

The most common ingredients used in the production of toy Slime 100 are water, polymeric materials, gelling agents, colorants, fillers, and preservatives. Regardless of the type of play compositions used, such materials must be safe for young children and no irritating to the skin or eyes or the like and be nontoxic if ingested.

The most abundant material in slime is water, typically making up over 90% of the formula. Water is a diluent that gives the slime its liquid consistency. The polymeric materials are responsible for the important characteristics of Slime. The most commonly used material is polyvinyl alcohol (PVA). In a typical Slime formula, about 2% PVA is needed. Another similar polymer is polyvinyl acetate (PVAC). This has a slightly different chemical makeup, but it behaves in the same way as PVA when a gelling agent is added. Certain “natural” polymers can also be used to produce Slime. Common examples include “guar gum”, which is derived from the bean of the guar plant, methylcellulose, which comes from plants, and cornstarch.

While the polymeric materials give Slime its substance, a gelling agent is needed to give it the non-Newtonian liquid behaviour. In classic Slime formulations, sodium borate (Borax) or sodium tetraborate is used. When dissolved in water, sodium borate dissociates into sodium ions and borate ions. If a polymer is present like PVA, the borate ions interact with the polymer chains and form weak ionic bonds that make the solution thicker. These bonds also give the ability to stretch when a force is applied. Typically, sodium borate makes up about 2% of the final product. The ratio of the polymer to the gelling agent is one factor in determining the consistency of the slime. To reach the accurate consistency in a Slime the ingredient-dispensing machine 30A provide a programmable velocity measurement device.

In a preferred embodiment of the present invention to provide an interactive Slime toy workshop 10 in which the customer is a part of the process of making the Slime, the dispensing-machines 30A and 30B are made of transparent material that all the process can be visible by the customer. The customer can observe which ingredients are selected to make their Slime toy.

As shown in FIG. 5A in an embodiment the ingredient-dispensing machine 30A has a plurality of chambers. A first chamber 31a include polymeric component source (PVC), the second chamber 32a includes gelling agent (Borax), the third chamber 33a includes diluent material (Water). Each chamber has a delivery device 31b, 32b and 33b which direct the materials to a nozzle 35 configured for ejecting a predetermined amount inside a container 200.

The ingredient-dispensing machine 30A further provides chambers 34a and relevant nozzle 34b for making customized Slime toy such as special ingredients for making Fluffy Slime, Putty Slime, Butter Slime, Soap Slime, etc. The ingredients to make different Slime forms will be dispensed from the chambers into the container 200. It is understood that the number and ingredients of the chamber will vary according to the present invention.

In another embodiment the ingredient-dispensing machine 30A have plurality of chambers. Each chamber contains a form of pre-fabricated Slime toy compositions that will be dispensed in the container to combine with add-ins.

The add-ins dispenser machine 30B is shown in FIG. 5B. The add-ins dispenser machine is also made of transparent material that all the process is visible by the customer. The customer can observe which add-ins are select for making their Slime toy. The add-ins dispenser machine further has a plurality of chambers 41a, 42a, 43a, 44a and 45a for receiving food colourings, glitters, beads, soap flakes, Gold Leafs, and Scents such as Lavender, Eucalyptus, Coconut, Lemon, Honey and other decorative materials to add to the base slime toy batch. Each chamber has a delivery nozzle 41b, 42b, 43b, 44b and 45b which directs the predetermined materials into a container 200.

The dispensing machines 30A, 30B provide a housing 36 to place a container 200. The housing 36 is configured to receive the containers 200 in various sizes and a barcode reader 203. By placing the container 200 in the housing 36 of the dispensing machine the information of the selected Slime toy 100 will be used to select the amount of the ingredients based on consistency of the selected Slime toy. After the container 200 is filled with the ingredient and add-ins, the customer will be directed to the mixing station where a mixing machine is situated.

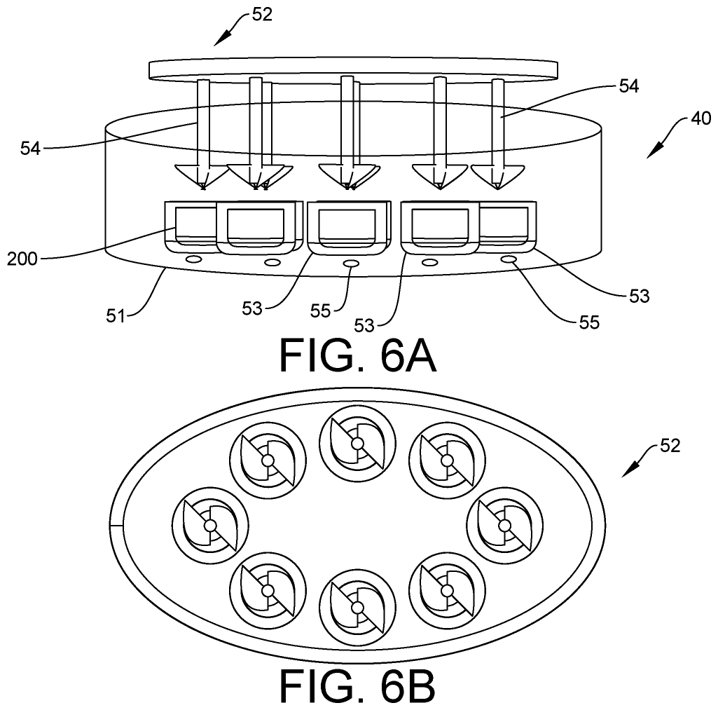

According to FIGS. 6A and 6B the mixing machine 40 can also be manufactured in a decorated theme according to the theme of the workshop 10 and in a manner to adapt to the special customers who are mostly children and young adults.

In one embodiment the mixing machine 40 is a compartment 51 with a lid 52 to prevent of any hazardous. The compartment 51 has a plurality housing 53 in 3 sizes: small, medium and large adapted to receive the containers 200. A plurality of mixer blades 54 are mounted on the inner side of the lid 52. The mixer blades 54 are so arranged that, by closing the lid 52, each blade 54 will mix the ingredients of a container below. The compartment 51 and the lid 52 of the mixing machine are further manufactured from transparent material so the customer can observe all the process of mixing the ingredients. The mixers 40 include a temperature and speed control system using computer controls to get the ingredients to mix and create a squishy Slime with an accurate consistency. Each mixer 40 is operated separately with a push button 55. By pushing the start button by the customer or the Associates the lid 52 will close and the mixing process will start.

Persons of ordinary skill in the art will realize that the devices in the stations and the drawings and explanations made below here serve to illustrate and educate on the invention and this is in no way limited to the presentation herein. Other embodiments of these devices will be readily used in the application to fulfil the main idea of an interactive workshop and method for making customized Slime toy.

In another embodiment the mixer station comprises of a plurality of individual mixers mounted on a table. Each mixer comprising a compartment and a lid wherein each mixer can receive a container at a time. The mixers lid will be closed to start the mixing process to prevent any hazardous for the customer.

In a still further embodiment the mixers are transportable.

Referring to FIG. 1 again a hand mixing station 50 is provided in mixing station, where the customers can fulfil their sensory experience as they dig in the Slime toy 100 and get gooey. Customers can choose, whether they want to mix their Slime toy 100 with the mixer 40 or by hand. If they decide to mix their ingredients by hand, they go to the hand mixing station 50 after they get their ingredients from dispenser machines. Users can experience the sensation of slime being squeezed between fingers, of stretching, pulling, and rolling the slime between their palms. They can feel the smoothness or softness texture as well as the tendency for slime and get messy. Customers can sit around the table, mix and play with their Slime toys, interact with each other, See other Slime forms of the other customers. The Retail Slime Store Associate Specialists are there to help the customers and answer the questions.

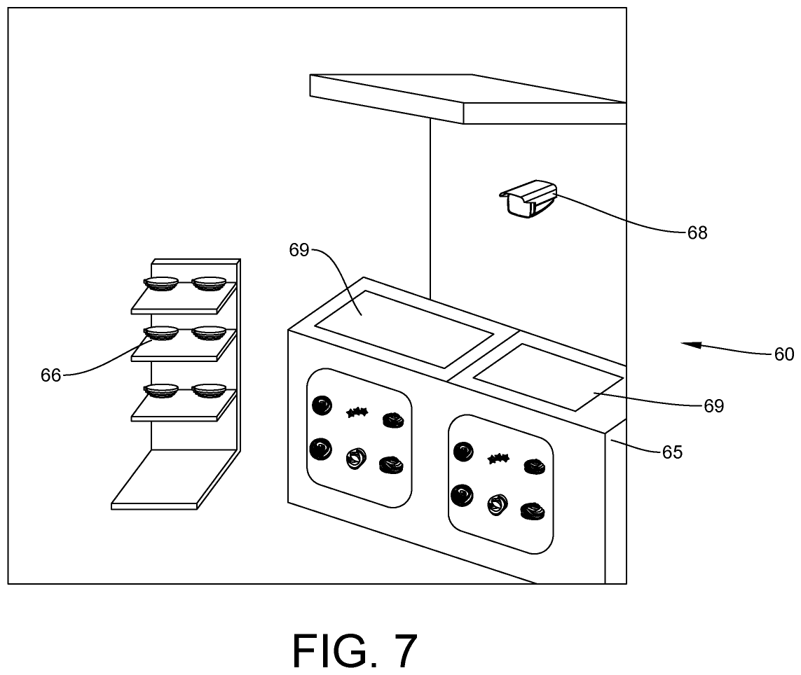

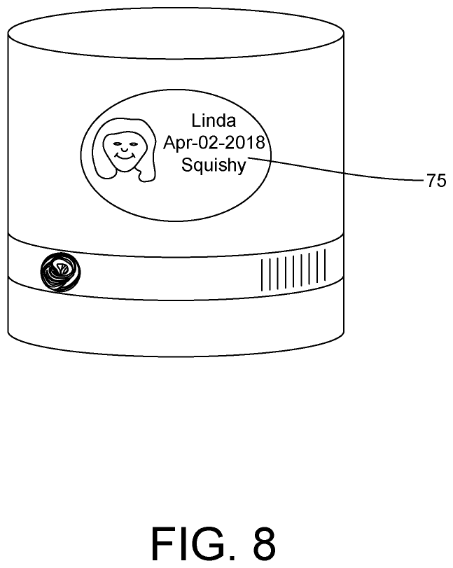

The final station is personalizing station 60. According to FIGS. 7 and 8 the personalizing activity can be assisted through the Associates in the workshop 10. A camera 68 is provided on the station to take a picture of the customer and create an Avatar image. The customer will be directed to a sticker label making machine 65 and get a printout sticker with a personalized image of the creator and their descriptive words of the Slime toy thereon 75. The customer will be asked to use descriptive words to describe what they have experienced, their senses and what they were feelings comprising: slippery, slimy, soft, squishy, heavy and smells and type it on touch screen devices 69 to specially stamp their Slime. The customer gets a lid from the lid counter 66 and fastens the container 200 and attach the sticker 75 on the container 200 and goes to the check-out desk for payment to take a customized squishy slime home.

In an embodiment upon personalizing station the customer provides a detailed personal information and builds a profile containing Name, date of birth, phone number, email and other information. The interactive workshop 10 could send individualized messages in special days.

The interactive workshop 10 can be used for celebrating special events, birthday parties and the stations can allow for a group (specifically the party) to move through the stations together in a collaborative experience.

In another embodiment the personnel of the workshop 10 could use handheld computing devices (such as Smartphones or tablet computers utilizing wireless communications) to access the information of each customer and the Slime form ordered by each customer by scanning the barcodes 202 to better assist them.

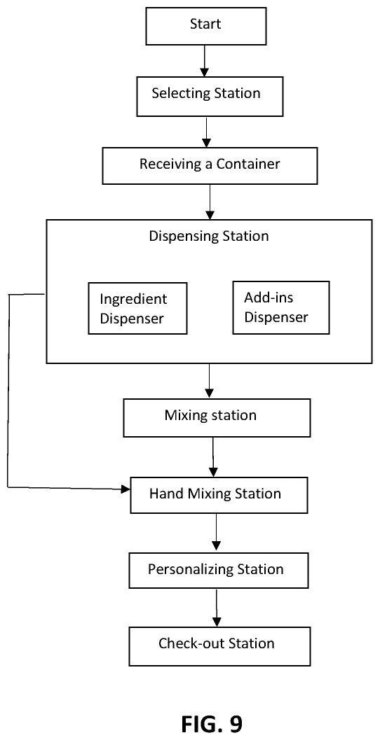

FIG. 9 is a diagram showing the steps of making a customized Slime toy in an interactive workshop according to the present invention.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

What is claimed is:

1) A method for creating a personalized slime by a customer, comprising:
presenting a slime menu of a set of slimes at a selecting station;
allowing the customer to select one of said set of slimes from the slime menu;
presenting a set of ingredients on the display for each of said set of slimes;
allowing the customer to select one of said set of ingredients;
presenting a set of add-ins on the display;
allowing the customer to select one of said set of add-ins to complete a selected slime;
inputting into the interface that the selected slime is complete, whereupon the electronic display presents a visual representation of the selected slime with add-ins on the display and allowing the customer to change any of the selections;
dispensing a container having a readable tag that contains a set of information regarding the selected slime;
presenting the container to a first dispensing machine, wherein said first dispensing machine reads the readable tag identifying the set of ingredients, and dispenses the set of ingredients into the container;
presenting the container to a second dispensing machine, wherein said second dispensing machine reads the readable tag identifying the set of add-ins and dispenses said set of add-ins into the container;
presenting the container to a mixing machine at a mixing station to mix the set of ingredients at a predefined condition to create the selected slime;
presenting the container to a personalizing station to personalize said slime by providing a label showing the visual representations of the selected slime.

2) The method of claim 1, wherein the slime menu of the set of slimes is presented on a display of an electronic device at the selecting station, and selecting one of said set of slimes from the slime menu using an interface of the electronic device;

3) The method of claim 2, wherein said selecting station comprising a touch screen to display the slime menu.

4) The method of claim 2, wherein said set of ingredients is presented adjacent the selected slime on the display, and wherein the one or more ingredients are selected by touching the display over selected ingredients.

5) The method of claim 1, wherein the method further comprising selecting a desired amount of each of said ingredients, whereupon a property of the slime is modified by changing the desired amount.

6) The method of claim 1, wherein said readable tag comprising a barcode having the information on said set of ingredients and add-ins.

7) The method of claim 1, wherein said dispensing station comprising a set of dispensers to dispense each of said set of ingredients, and an add-in-dispenser to dispense said set of add-ins.

8) The method of claim 1, wherein said dispenser further provide a computer program to control and measure said set of ingredients based on said set of information on said barcode.

9) The method of claim 1, wherein said set of ingredients are selected from a group consisting of polymeric materials, gelling materials, and abundant materials, wherein said polymeric materials being PVC or PVAC, said gelling material being Borax, and said abundant material being water.

10) The method of claim 1, wherein said set of ingredients are selected from a group consisting of prefabricated Slime.

11) The method of claim 1, wherein said set of ingredients comprising edible material, wherein said edible material being guar gum, Methylcellulose and cornstarch.

12) The method of claim 1, wherein said personalizing station provides a sticker with a picture and a name of the customer.
